(19) United States
(12) Patent Application Publication
(10) Pub. No.: US 2024/0094374 A1
(43) Pub. Date: Mar. 21, 2024

(54) Electronic Devices with Doppler-Based Object Detection

(71) Applicant: Apple Inc., Cupertino, CA (US)

(72) Inventors: Michael Ney, Be'er Sheva (IL); Michael Kerner, Tel Mond (IL); Lev Grobman, Tel Aviv-Yafo (IL)

(21) Appl. No.: 18/464,567

(22) Filed: Sep. 11, 2023

Related U.S. Application Data
(60) Provisional application No. 63/408,396, filed on Sep. 20, 2022.

(51) Int. Cl. G01S 13/56; G01S 7/40

(52) U.S. Cl. CPC G01S 13/56; G01S 7/4013

(57) ABSTRACT

An electronic device may include sensing circuitry that transmits radar signals and receives reflected signals over a set of antennas. Communications circuitry may use the antennas to transmit communications data subject to a maximum transmit power level. The sensing circuitry may generate Doppler information based on the reflected signals and may detect whether an external object is on a surface of the device based on the Doppler information. When the external object is detected on the surface, the external object is not within a hot-spot cone of the antennas and the communications circuitry may transmit the communications data without reducing the maximum transmit power level. When the external object is detected off the surface, the external object may be within the hot-spot cone and the communications circuitry may transmit the communications data with a reduced maximum transmit power level to satisfy regulatory limits on radio-frequency exposure or absorption.

This application claims the benefit of U.S. Provisional Patent Application No. 63/408,396, filed Sep. 20, 2022, which is hereby incorporated by reference herein in its entirety.

### FIELD

This disclosure relates generally to electronic devices and, more particularly, to electronic devices with wireless circuitry.

### BACKGROUND

Electronic devices are often provided with wireless capabilities. An electronic device with wireless capabilities has wireless circuitry that includes one or more antennas. The wireless circuitry is sometimes used to perform spatial ranging operations in which radio-frequency signals are used to estimate a distance between the electronic device and external objects. The estimated distance can be used to adjust the operation of the one or more antennas.

However, if care is not taken, this distance alone might not provide sufficient information to adjust the operation of the one or more antennas in a manner that fully complies with regulatory limits on radio-frequency emission and absorption.

### SUMMARY

An electronic device may include wireless circuitry controlled by one or more processors. The wireless circuitry may include communications circuitry for performing wireless communications. The wireless circuitry may include sensing circuitry for performing range detection on an external object. The sensing circuitry may transmit radar signals over one or more antennas. The sensing circuitry may receive reflected radar signals over the one or more antennas. Communications circuitry may use the one or more antennas to transmit communications data subject to a maximum transmit power level.

The sensing circuitry may generate Doppler information based on the reflected radar signals. The sensing circuitry may detect whether the external object is on or off a surface of the device based on the Doppler information. When the external object is detected on the surface, this may be indicative of an angle to the external object exceeding a threshold such that the external object is not within a hot-spot cone of the one or more antennas. The communications circuitry may then transmit the communications data without reducing the maximum transmit power level, thereby maximizing communications performance. When the external object is detected off the surface, this may be indicative of the angle to the external object being less than the threshold such that the external object is within the hot-spot cone of the one or more antennas. The communications circuitry may then transmit the communications data with a reduced maximum transmit power level to satisfy regulatory limits on radio-frequency exposure or absorption.

An aspect of the disclosure provides an electronic device. The electronic device can include one or more antennas configured to transmit radar signals and to receive reflected radar signals. The electronic device can include one or more processors configured to detect, based on the reflected radar signals, whether an external object is on a surface of the electronic device. The electronic device can include a transmitter coupled to the one or more antennas, wherein the transmitter is configured to use the one or more antennas to transmit wireless signals with a first maximum transmit power level when the external object is detected on the surface, and transmit the wireless signals with a second maximum transmit power level when the external object is detected off the surface.

An aspect of the disclosure provides a method of operating an electronic device. The method can include with one or more antennas, transmitting radar signals. The method can include with the one or more antennas, receiving reflected radar signals. The method can include with one or more processors, generating, based on the reflected radar signals, Doppler information associated with an external object. The method can include with the one or more processors, adjusting a maximum transmit power level of the one or more antennas based on the Doppler information.

An aspect of the disclosure provides a method of operating an electronic device. The method can include with one or more antennas, transmitting radar signals. The method can include with the one or more antennas, receiving reflected radar signals. The method can include with one or more processors, reducing a maximum transmit power level of the one or more antennas when an angle, to an external object and relative to a boresight of the one or more antennas, is less than a threshold angle.

### BRIEF DESCRIPTION OF THE DRAWINGS

FIG. 1 is a block diagram of an illustrative electronic device having sensing circuitry for performing external object detection using antennas in accordance with some embodiments.

FIG. 2 is a perspective view showing how an external object may be present at different locations around a set of antennas used to perform external object detection in accordance with some embodiments.

FIG. 3 is a flow chart of illustrative operations that may be performed by sensing circuitry to adjust one or more antennas based on a range to the external object, based whether the external object is animate, and based on whether the external object is present on a surface of an electronic device in accordance with some embodiments.

FIG. 4 is a circuit diagram of illustrative sensing circuitry having a de-chirp mixer and Doppler processing circuitry in accordance with some embodiments.

FIG. 5 is a circuit diagram of illustrative Doppler processing circuitry for determining whether an external object is present on a surface of an electronic device in accordance with some embodiments.

FIG. 6 is a flow chart of illustrative operations that may be performed by Doppler processing circuitry to determine whether an external object is present on a surface of an electronic device in accordance with some embodiments.

FIG. 7 is a plot of an illustrative range-Doppler map that may be generated by Doppler processing circuitry in accordance with some embodiments.

FIG. 8 is a plot of an illustrative time-Doppler map that may be generated by Doppler processing circuitry based on range-Doppler maps in accordance with some embodiments.

FIG. 9 is a plot showing how a width metric of a range-Doppler map may be compared to a threshold value to determine whether an external object is present on a surface of an electronic device in accordance with some embodiments.

### DETAILED DESCRIPTION

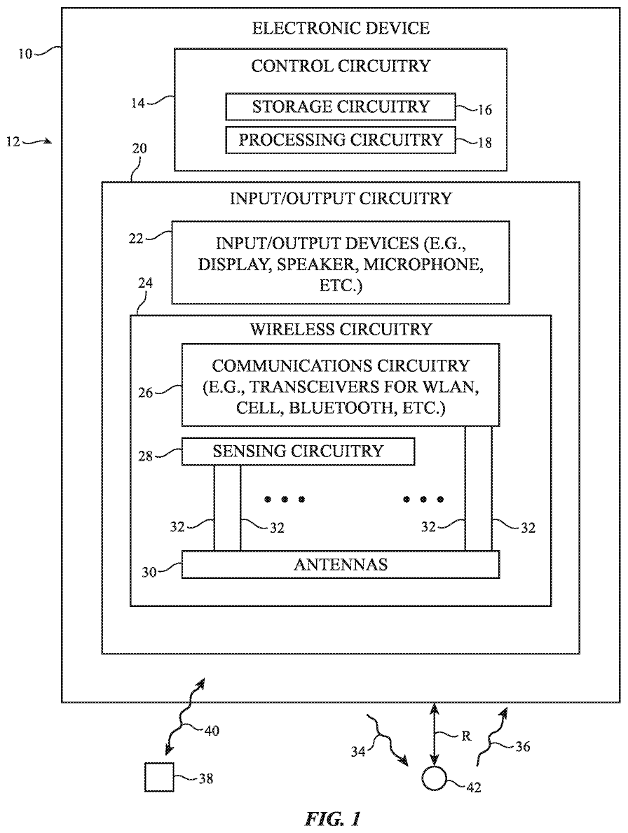

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, 6G protocols, etc.), antenna diversity protocols, satellite navigation system protocols (e.g., global positioning system (GPS) protocols, global navigation satellite system (GLONASS) protocols, etc.), antenna-based spatial ranging protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications and radio-based sensing operations. Wireless circuitry 24 (sometimes referred to herein as wireless communications circuitry 24) may include two or more antennas 30. Wireless circuitry 24 may also include baseband processor circuitry, transceiver circuitry, amplifier circuitry, filter circuitry, switching circuitry, analog-to-digital converter (ADC) circuitry, digital-to-analog converter (DAC) circuitry, radio-frequency transmission lines, and/or any other circuitry for transmitting and/or receiving radio-frequency signals using antennas 30.

Antennas 30 may be formed using any desired antenna structures for conveying radio-frequency signals. For example, antennas 30 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antennas 30 over time. If desired, two or more of antennas 30 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given beam pointing direction.

The term “convey radio-frequency signals” as used herein means the transmission and/or reception of the radio-frequency signals (e.g., for performing unidirectional and/or bidirectional wireless communications with external wireless communications equipment). Antennas 30 may transmit the radio-frequency signals by radiating the radio-frequency signals into free space (or to free space through intervening device structures such as a dielectric cover layer). Antennas 30 may additionally or alternatively receive the radio-frequency signals from free space (e.g., through intervening devices structures such as a dielectric cover layer). The transmission and reception of radio-frequency signals by antennas 30 each involve the excitation or resonance of antenna currents on an antenna resonating element in the antenna by the radio-frequency signals within the frequency band(s) of operation of the antenna.

Wireless circuitry 24 may include communications circuitry 26 (sometimes referred to herein as wireless communications circuitry 26) for transmitting and/or receiving wireless communications data using antennas 30 (e.g., using wireless signals 40 conveyed with external equipment 38 such as a wireless access point or base station). Communications circuitry 26 may include baseband circuitry (e.g., one or more baseband processors) and one or more radios (e.g., radio-frequency transceivers, modems, etc.) for conveying radio-frequency signals using one or more antennas 30. Communications circuitry 26 may use antennas 30 to transmit and/or receive radio-frequency signals that convey the wireless communications data between device 10 and external wireless communications equipment (e.g., one or more other devices such as device 10, a wireless access point or base station, etc.). The wireless communications data may be conveyed bidirectionally or unidirectionally. The wireless communications data may, for example, include data that has been encoded into corresponding data packets such as wireless data associated with a telephone call, streaming media content, internet browsing, wireless data associated with software applications running on device 10, email messages, etc.

Communications circuitry 26 may transmit and/or receive radio-frequency signals within corresponding frequency bands at radio frequencies (sometimes referred to herein as communications bands or simply as “bands”). The frequency bands handled by communications circuitry 26 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands around 100-1000 GHz (sub-THz, THz, or THF bands) etc.), other centimeter or millimeter wave frequency bands between 10-300 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

In addition to conveying wireless communications data, wireless circuitry 24 may also use antennas 30 to perform radio-frequency sensing operations (sometimes referred to herein as radio-based sensing operations, spatial ranging operations, radio detection and ranging (radar) operations, or simply as sensing operations). The sensing operations may allow device 10 to detect (e.g., sense or identify) the presence, location, orientation, and/or velocity (motion) of objects external to device 10 such as external object 42. Detecting, sensing, or identifying the presence, location, orientation, and/or velocity (motion) of external object 42 at any given time or over a given time period may sometimes be referred to herein simply as detecting the external object or performing spatial ranging operations, ranging operations, radio-based sensing operations, or range detection. The sensing operations may be performed over a relatively short range such as ranges of a few cm from antennas 30 or over longer ranges such as ranges of dozens of cm, a few meters, dozens of meters, etc.

External object 42 may be, for example, the ground, a building, part of a building, a wall, furniture, a ceiling, a person, a body part (e.g., the head, hand, finger, or other body part of the user of device 10 or other humans in the vicinity of device 10), an animal, a vehicle, a landscape or geographic feature, an obstacle, external communications equipment, another device of the same type as device 10 or a peripheral/accessory device such as a gaming controller, stylus (e.g., for providing input to a touch and/or force-sensitive display on device 10), or remote control, or any other physical object or entity that is external to device 10. External object 42 may be an animate (moving or living) object or an inanimate (stationary or non-living) object.

Control circuitry 14 may use the detected presence, location, orientation, and/or velocity of external object 42 to perform any desired device operations. As examples, control circuitry 14 may use the detected presence, location (e.g., range R and/or position), orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer a radio-frequency signal beam produced by antennas 30 for communications circuitry 26 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc.

Wireless circuitry 24 may include sensing circuitry 28 for performing radio-based sensing operations using antennas 30. Sensing circuitry 28 may include a sensing transmitter (e.g., transmitter circuitry including signal generators, synthesizers, etc.), a sensing receiver, mixer circuitry, amplifier circuitry, filter circuitry, baseband circuitry, ADC circuitry, DAC circuitry, and/or any other desired components used in performing sensing operations using antennas 30. Sensing circuitry 28 may perform the sensing operations using radio-frequency sensing signals such as sensing signals 34 that are transmitted by antennas 30 (sometimes referred to herein as radar signals 34) and using reflected versions of the transmitted sensing signals that have reflected off an external object around device 10 such as external object 42 (sometimes referred to herein as reflected sensing signals 36, reflected signals 36, or reflected radar signals 36). Sensing circuitry 28 may, for example, transmit and receive radar signals using a frequency-modulated continuous-wave (FMCW) scheme, a full-duplex ranging scheme, or other ranging schemes. Antennas 30 may include separate antennas for conveying wireless communications data for communications circuitry 26 and for conveying radar signals or may include one or more antennas 30 that are used to both convey wireless communications data and to perform sensing operations. Using a single antenna 30 to both convey wireless communications data and perform sensing operations may, for example, serve to minimize the amount of space occupied in device 10 by antennas 30.

Sensing circuitry 28 may be coupled to antennas 30 over at least two radio-frequency transmission line paths 32. Communications circuitry 26 may be coupled to antennas 30 over at least one radio-frequency transmission line path 32. Separate radio-frequency transmission line paths 32 may couple sensing circuitry 28 and communications circuitry 26 to antennas 30 (e.g., as shown in FIG. 1) or one or more radio-frequency transmission line paths 32 may couple one or more antennas 30 to both sensing circuitry 28 and communications circuitry 26. If desired, sensing circuitry 28 may be integrated into communications circuitry 26 (e.g., communications circuitry 26 may also perform spatial ranging operations).

Radio-frequency transmission line paths 32 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission line paths 32 may be integrated into rigid and/or flexible printed circuit boards if desired. Radio-frequency front end (RFFE) modules may be interposed on one or more radio-frequency transmission line paths 32. The radio-frequency front end modules may include substrates, integrated circuits, chips, or packages that are separate from sensing circuitry 28 and communications circuitry 26 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission line paths 32.

The example of FIG. 1 is illustrative and non-limiting. While control circuitry 14 is shown separately from wireless circuitry 24 in the example of FIG. 1 for the sake of clarity, wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of communications circuitry 26 and/or sensing circuitry 28. The baseband circuitry may, for example, access a communication protocol stack on control circuitry 14 (e.g., storage circuitry 20) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer. If desired, the PHY layer operations may additionally or alternatively be performed by radio-frequency (RF) interface circuitry in wireless circuitry 24.

In some implementations that are described herein as an example, sensing circuitry 28 may be used to detect the position of external object 42 for use in ensuring that antennas 30 comply with regulatory requirements on the exposure/absorption of radio-frequency energy by human tissue (e.g., maximum permissible exposure (MPE) limits, specific absorption rate (SAR) limits, or other regulatory limits). In general, maximizing transmitted power for communications circuitry 26 allows device 10 to achieve optimal performance in conveying wireless data with external equipment 38. However, if care is not taken, such high transmit power levels can cause device 10 to violate regulatory limits on exposure/absorption when external object 42 is a human body part and when external object 42 is at a location subject to significant exposure/absorption of radio-frequency energy. Sensing external object 42 using sensing circuitry 28 may offer several advantages over other types of sensors such as image sensors. For example, sensing circuitry 28 may exhibit more privacy, a smaller sensing form factor, and a wider field of view than image sensors. In addition, sensing circuitry 28 may function in any lighting conditions, unlike image sensors.

Without knowledge of the presence of human body parts near transmitting antennas 30, a reduced maximum transmit power limit needs to be set for the antennas to satisfy the regulatory requirements (e.g., a maximum transmit power level lower than the maximum transmit power level supported by power amplifiers in communications circuitry 26), sacrificing communications performance of those antennas 30. Achieving awareness of the presence of human body parts near or relative to active antennas 30 using radar sensing (e.g., sensing circuitry 28) may serve to maximize the communications performance of the antennas. For example, the sensing circuitry may allow communications circuitry 26 to maximize its emitted power level (e.g., without any maximum transmit power level backoff) when no human is at risk of exposure exceeding the regulatory limits (e.g., when external object 42 is not human or not at a location subject to substantial radio-frequency exposure), while backing off maximum transmit power level only when human presence is detected at a location that risks exposure exceeding the regulatory limits.

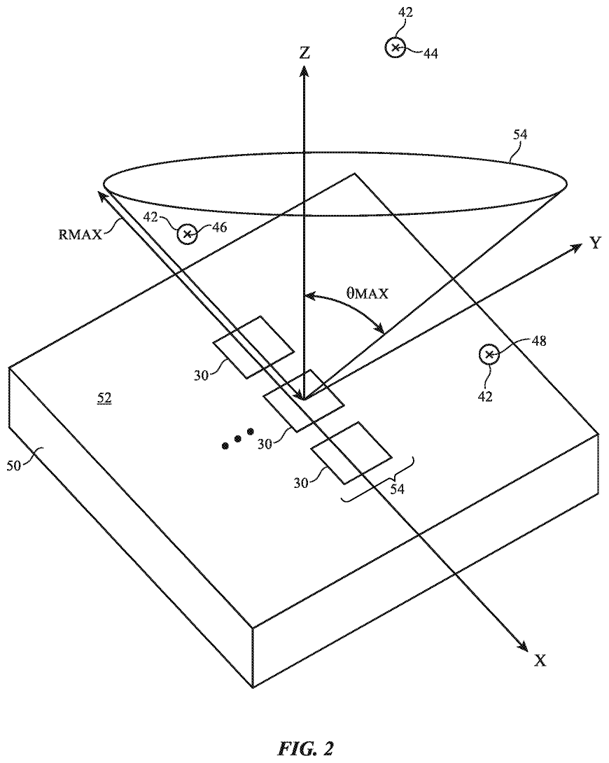

FIG. 2 is a perspective view showing how external object 42 may be at different locations relative to antennas 30 on device 10. As shown in FIG. 2, one or more antennas 30 may be disposed on surface 52 of a substrate 50. Substrate 50 may be a portion of the housing for device 10, a printed circuit board within device 10, a dielectric cover layer for device 10, or any other desired dielectric substrate on or within device 10. Surface 52 may sometimes be referred to herein as a surface of device 10 (e.g., an external surface of device 10 or a surface internal to device 10). The antennas 30 at surface 52 may form all or part of a phased antenna array or may not be integrated into a phased antenna array.

The transmit power distribution around an antenna array defines the region in space in which a human body part cannot be present without violating the regulatory limits on radio-frequency exposure/absorption. Localization and classification of targets (external objects 42) should be performed with respect to this region in space to determine the allowed level of emitted power. The portion of the transmit power distribution in which a human target may not be present without violating the regulatory limits, sometimes referred to as a “hot spot,” may be approximated by a finite cone around the normal axis to the plane in which the array is present (boresight direction).

For example, as shown in FIG. 2, cone 54 represents such a three-dimensional spatial region (hot spot region) for antennas 30 on surface 52. Cone 54 may be defined by a maximum elevation angle θMAX with respect to boresight (e.g., the Z-axis) and a maximum range RMAX relative to surface 52 (e.g., the center of the array). At ranges beyond maximum range RMAX from antennas 30, external object 42 is sufficiently far from antennas 30 that the over-the-air attenuation of transmitted signals prevents the external object from being exposed to radio-frequency energy exceeding the regulatory limits (regardless of the elevation angle to the external object). For example, when external object 42 is at location 44 (e.g., an elevation angle less than maximum angle θMAX but a range greater than maximum range RMAX), device 10 is not at risk of violating the regulatory limits and the maximum transmit power level of antennas 30 need not be reduced (e.g., device 10 may impose no limit on maximum permissible power emission). Maximum range RMAX may be, for example, 6 cm, 10 cm, 1-10 cm, 1 cm, or other ranges.

Similarly, at angles above maximum angle θMAX, the radiation pattern of antennas 30 is relatively weak, preventing external object 42 from being exposed to radio-frequency energy exceeding the regulatory limits (regardless of the range R to the external object). For example, when external object 42 is at location 48 (e.g., an elevation angle exceeding maximum angle θMAX but a range much less than maximum range RMAX), device 10 is not at risk of violating the regulatory limits and the maximum transmit power level of antennas 30 need not be reduced (e.g., device 10 may impose no limit on maximum permissible power emission). External object 42 may, for example, be the user's hand, which may be at location 48 when the user is holding/gripping device 10 (e.g., to interact with a touch screen or other input devices on device 10 or simply to hold device 10 without actively interacting with device 10).

However, when external object 42 is located within cone 54 (e.g., at a range R less than maximum range RMAX and at an angle θ less than maximum angle θMAX), external object 42 is located within the primary radiation pattern of antennas 30 and is subject to radio-frequency energy that may exceed the regulatory limits. As such, device 10 may need to reduce the maximum transmit power level of communications circuitry 26 when the external object is at a location within cone 54. For example, when external object 42 is at location 46 (e.g., an elevation angle less than maximum angle θMAX and a range less than maximum range RMAX), device 10 is at risk of violating the regulatory limits and the maximum transmit power level of antennas 30 may be reduced (e.g., device 10 may impose a limit on maximum permissible power emission) to ensure compliance with the regulatory limits.

Each antenna 30 on surface 52 may transmit radar signals 34 and/or may receive reflected radar signals 36 (FIG. 1). If desired, one or more antennas 30 may both transmit radar signals 34 and receive reflected radar signals 36. One or more of the antennas 30 on surface 52 may also convey wireless signals 40 between communications circuitry 26 and external equipment 38 (e.g., for conveying wireless communication data).

In general, only a single antenna 30 may be needed to receive reflected radar signals 36 for identifying the range R between that antenna 30 and external object 42 (e.g., based on time-of-flight of the radar signals to and from the external object). However, multiple antennas 30 arranged in a two-dimensional grid pattern may need to receive reflected radar signals 36 to identify the angle θ of external object. For example, each of the antennas 30 may generate a respective range R to the external object and the ranges may be combined to triangulate the position and thus the angle θ of the external object. Such a two-dimensional grid pattern may consume an excessive amount of area on substrate 50, particularly given that space is at a premium in compact devices such as device 10. It would therefore be desirable to be able to determine whether external object 42 is present within cone 54 regardless of the geometry of the number and geometry of antennas 30 on substrate 50.

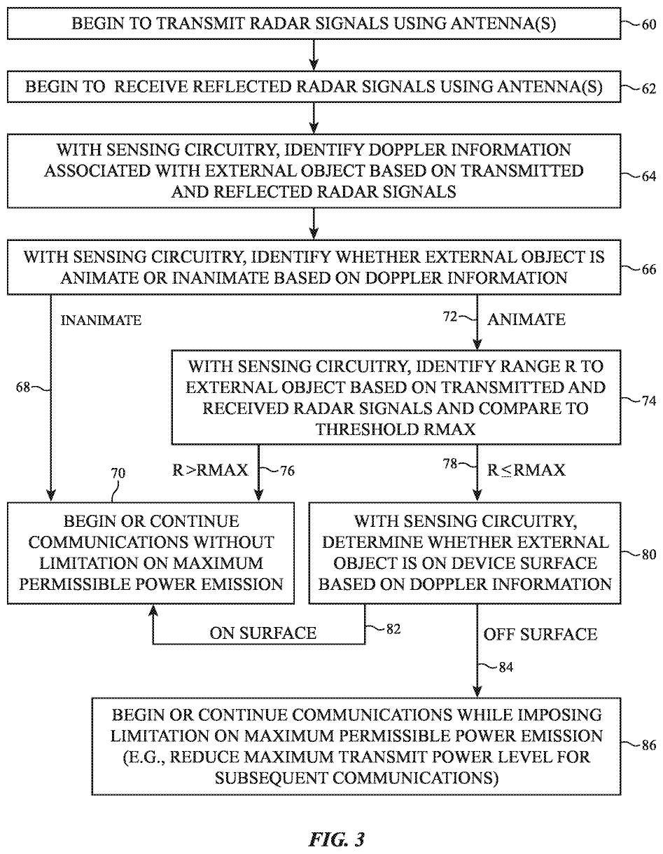

To mitigate these issues, sensing circuitry 28 may detect external object 42 and may adjust the maximum transmit power level of antennas 30 based on Doppler shifts in the received reflected radar signals 36. FIG. 3 is a flow chart of illustrative operations that may be performed by sensing circuitry 28 to adjust the maximum transmit power level of antennas 30 based on Doppler shifts in the received reflected radar signals 36.

At operation 60, sensing circuitry 28 may begin to periodically transmit radar signals 34 or other sensing signals into the surroundings of device 10 using one or more of the antennas 30 on surface 52. The transmitted radar signals 34 may include periodic waveforms such as, for example, linear frequency ramps (sometimes referred to as chirps or chirp signals, in implementations where sensing circuitry 28 has an FMCW architecture). When an external object 42 is present at, around, near, or adjacent to device 10, some of the transmitted radar signals 34 will reflect off external object 42 as reflected radar signals 36. External object 42 may sometimes be referred to herein as target object 42 or target 42.

At operation 62, sensing circuitry 28 may begin to receive reflected radar signals 36 using one or more of the antennas 30 on surface 52 (e.g., the same antenna(s) or different antenna(s) than the antenna(s) that transmitted radar signals 34). Sensing circuitry 28 may continue to transmit radar signals 34 and to receive reflected radar signals 36 concurrent with one or more of the remaining operations of FIG. 3 (e.g., operations 60 and 62 may continue to be performed concurrently with operations 64-86).

At operation 64, sensing circuitry 28 may process the received reflected radar signals 36 and/or the transmitted radar signals 34 to identify Doppler information associated with the external object 42 that reflected the radar signals (e.g., sensing circuitry 28 may generate the Doppler information based on the transmitted and/or received signals). The Doppler information may sometimes be referred to herein as the Doppler signature of external object 42 and may, for example, include one or more Doppler shifts imparted to reflected radar signals 34 by external object 42 due to motion of external object 42 relative to device 10 (e.g., over time). Doppler shifts are positive or negative changes in the frequency of the reflected signal produced by movement of external object 42 along the radial direction relative to antenna(s) 30 (e.g., changes in frequency relative to the frequency of the radar signals 34 incident upon external object 42 or relative to the frequency of reflected radar signals 36 when external object 42 is completely stationary with respect to surface 52).

At operation 66, sensing circuitry 28 may identify whether external object 42 is animate or inanimate based on the Doppler information (or any other information gathered from the transmitted and/or received radar signals). In general, animate objects implicate the regulatory limits on radio-frequency exposure/absorption, whereas inanimate objects are not subject to regulatory limits. Examples of inanimate objects include a removable case for device 10, a tabletop, furniture, walls, a peripheral (accessory) device, or other objects.

The human body, which implicates the regulatory limits, is an animate object. More particularly, human body parts cannot remain perfectly still, as a natural very slight motion is always present (e.g., with a minimal amplitude on the order of 1-2 mm or less). Such motion may include actual external motions of the body part or a slight internal motion of the body part, such as blood flow. The Doppler information gathered by sensing circuitry 28 is very sensitive to motion. As such, the sensing circuitry can detect even the most minute movements of a human body part to distinguish an animate external object 42 from an inanimate external object 42. On the other hand, inanimate objects either exhibit no motion or exhibit a Doppler signature that is different from the Doppler signature of animate objects (e.g., due to the presence or absence of characteristic movements unique to body parts such as internal blood flow).

If sensing circuitry 28 determines that external object 42 is inanimate, processing may proceed to operation 70 over path 68. Sensing circuitry 28 may determine that external object 42 is animate if the Doppler information shows that external object 42 produced a Doppler shift of zero or a Doppler shift less than a threshold Doppler shift, if sensing circuitry 28 detects, from the Doppler information, that external object 42 exhibits less motion or velocity than a threshold amount of motion or velocity, or if sensing circuitry 28 detects that external object 42 otherwise produces Doppler shifts in the reflected radar signals that are characteristic of objects other than a human body part.

At operation 70, communications circuitry 26 (FIG. 1) may begin or continue using antennas 30 to convey wireless signals 40 with external equipment 38 without reducing or backing off maximum transmit power level (e.g., without a limitation on maximum permissible power emission). Since external object 42 is inanimate in this case, the amount of radio-frequency energy absorbed or exposed to the external object is not subject to the regulatory limits. Device 10 will thereby be able to maximize the radio-frequency performance of communications circuitry 26 while ensuring that device 10 satisfies the regulatory limits. If sensing circuitry 28 determines that external object 42 is animate, processing may proceed from operation 66 to operation 74 over path 72. Sensing circuitry 28 may determine that external object 42 is animate if the Doppler information shows that external object 42 produced a Doppler shift that exceeds a threshold Doppler shift, if sensing circuitry 28 detects, from the Doppler information, that external object 42 exhibits more motion or velocity than a threshold amount of motion or velocity, or if sensing circuitry 28 detects that external object 42 otherwise produces Doppler shifts in the reflected radar signals that are characteristic of a human body part.

At operation 74, sensing circuitry 28 may identify range R from antenna(s) 30 to external object 42 based on the Doppler information and/or any other information associated with or gathered from the transmitted and/or received radar signals. Sensing circuitry 28 may compare range R to maximum range RMAX to determine whether range R exceeds maximum range RMAX. If desired, R may also be compared to a minimum range RMIN and, if R is less than minimum range RMIN, processing may proceed directly to operation 86.

If sensing circuitry 28 determines that external object 42 is at a range R that exceeds maximum range RMAX, processing may proceed to operation 70 over path 76. Communications circuitry 26 (FIG. 1) may then begin or continue using antennas 30 to convey wireless signals 40 with external equipment 38 without backing off maximum transmit power level (e.g., without a limitation on maximum permissible power emission). Since external object 42 is farther than maximum range RMAX in this case (e.g., at location 44 of FIG. 2), external object 42 is outside of cone 54 and the amount of radio-frequency energy absorbed or exposed to the external object will be less than the regulatory limits. Device 10 will thereby be able to maximize the radio-frequency performance of communications circuitry 26 while ensuring that device 10 satisfies the regulatory limits.

If sensing circuitry 28 determines that external object 42 is at a range R that is less than or equal to (e.g., within) maximum range RMAX, processing may proceed from operation 74 to operation 80 over path 78. While the motion of external object 42 or the resultant Doppler signature can be used to determine whether a target is animate or inanimate, the Doppler signature may also be used to determine whether or not an animate target is within cone 54 (FIG. 2) in terms of angle θ, complementing the detected range R. Animate targets that are outside of cone 54 (e.g., when the angle θ of external object 42 is greater than maximum angle θ_{MAX}) are most likely located on the surface of device 10 (e.g., surface 52 of FIG. 2). Such situations most often occur when the user is holding or gripping device 10 in their hand. As the external object (e.g., the user's fingers) are located on the surface of device 10, the natural motion of the external object is dampened but is not eliminated. This dampening may be detectable in the gathered Doppler information. The Doppler signature of on-surface animate targets is therefore different from the Doppler signature of animate targets located “in air” (e.g., within cone 54).

At operation 80, sensing circuitry 28 may determine, based on the Doppler information, whether or not external object 42 is present on surface 52 of device 10 (e.g., at or contacting surface 52). For example, sensing circuitry 28 may compare the Doppler signature of external object 42 to Doppler signatures characteristic of an animate external object 42 being present on the surface of device 10 and of an animate external object 42 being present in the air over the surface (within cone 54) (e.g., by comparing the Doppler signature to one or more threshold values).

If sensing circuitry 28 determines that external object 42 is on the surface of device 10 (e.g., surface 52 of FIG. 2), this is indicative of external object 42 being located at an angle θ that exceeds maximum angle θMAX and thus being located outside of cone 54. As such, processing may proceed to operation 70 via path 82. Communications circuitry 26 (FIG. 1) may then begin or continue using antennas 30 to convey wireless signals 40 with external equipment 38 without backing off maximum transmit power level (e.g., without a limitation on maximum permissible power emission). Since external object 42 is at a higher angle θ than maximum angle θMAX in this case (e.g., at location 48 of FIG. 2), external object 42 is outside of cone 54 and the amount of radio-frequency energy absorbed or exposed to the external object will be less than the regulatory limits (e.g., given the radiation pattern of antennas 30). Device 10 will thereby be able to maximize the radio-frequency performance of communications circuitry 26 while ensuring that device 10 satisfies the regulatory limits.

If sensing circuitry 28 determines that external object 42 is not on the surface of device 10 (e.g., surface 52 of FIG. 2), this is indicative of external object 42 being located at an angle θ that is less than maximum angle θMAX and thus being located inside of cone 54. As such, processing may proceed from operation 80 to operation 86 via path 84. Communications circuitry 26 (FIG. 1) may then begin or continue using antennas 30 to convey wireless signals 40 with external equipment 38 while backing off (reducing) the maximum transmit power level of the antenna(s) (e.g., using control signals provided to one or more power amplifiers or amplifier stages in one or more transmitters in communications circuitry 26 of FIG. 1 to operate at less than maximum power, thereby imposing a limitation on maximum permissible power emission). Since external object 42 is at a lower angle θ than maximum angle θMAX in this case (e.g., at location 46 of FIG. 2), external object 42 is within cone 54 and the reduction in maximum transmit power level may allow device 10 to continue to satisfy the regulatory limits on radio-frequency exposure/absorption.

In this way, sensing circuitry 28 may minimize the number of situations and thus the amount of time in which a reduction in maximum transmit power level is imposed, thereby optimizing wireless performance of communications circuitry 26. At the same time, sensing circuitry 28 may accurately and rapidly assess the location of external object 42, accounting for angle θ, regardless of the number or geometry of antennas 30 used to transmit and/or receive radar signals. The example of FIG. 3 is illustrative and non-limiting. If desired, device 10 may increase the maximum transmit power level for antenna(s) 30 while processing operation 70. Operations 64-80 may be performed in other orders. Two or more of operations 66-80 may be performed concurrently if desired.

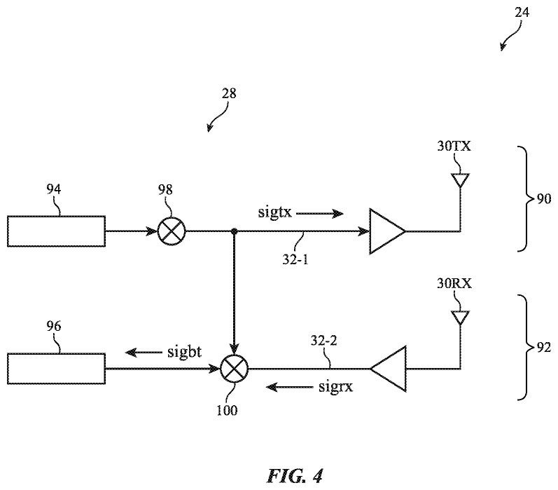

FIG. 4 is a simplified circuit diagram showing one example of how sensing circuitry 28 may implement an FMCW radar architecture. As shown in FIG. 4, wireless circuitry 24 may include a transmit path 90 (sometimes referred to herein as transmit chain 90) and a receive path 92 (sometimes referred to herein as receive chain 92). Transmit path 90 may include a transmit antenna 30TX coupled to a radio-frequency transmission line path 32-1 having one or more power amplifiers. Receive path 92 may include a receive antenna 30RX coupled to a radio-frequency transmission line path 32-2 having one or more low noise amplifiers. Transmit antenna 30TX and receive antenna 30RX may be different antennas or may, if desired, be the same antenna.

Transmit path 90 may include a signal generator 94. Signal generator 94 may include a synthesizer, modulator, digital-to-analog converter (DAC), clocking circuitry, and/or any other desired circuitry that generates radar signals sigtx (e.g., linear frequency ramps or chirp signals) on transmit path 90. One or more mixers such as mixer 98 may be disposed on transmit path 90 for upconverting radar signals sigtx from baseband to radio frequencies. Transmit antenna 30TX may transmit radar signals sigtx (e.g., as radar signals 34 of FIG. 1). Some of the transmitted radar signals sigtx will reflect off external object 42 as reflected radar signals sigrx, inheriting some of the properties of external object 42 (e.g., reflected radar signals sigrx may have or exhibit a Doppler shift produced by motion of external object 42).

Receive path 92 may include Doppler processing circuitry such as Doppler processor 96. Receive antenna 30RX may receive reflected radar signals sigrx (e.g., reflected radar signals 36 of FIG. 1). Receive path 92 may include a de-chirp mixer 100. De-chirp mixer 100 may have a first input coupled to transmit path 90 (e.g., over a de-chirp path) and a second input coupled to receive antenna 30RX over radio-frequency transmission line path 32-2. The first input of de-chirp mixer 100 may receive the radar signals sigtx transmitted over transmit path 90. The second input of de-chirp mixer 100 may receive the corresponding reflected radar signals sigrx reflected off external object 42 and received by receive antenna 30RX. As received, reflected radar signals sigrx will be offset in time with respect to the transmitted radar signals sigtx (e.g., due to the time-of-flight of the radar signals to external object 42 and back). The reflected radar signals sigrx may also be offset in frequency with respect to the transmitted radar signals sigtx (e.g., due to a Doppler shift imparted to the radar signals by motion of external object 42).

De-chirp mixer 100 may mix (e.g., self-mix) the transmitted radar signals sigtx with the received reflected radar signals sigrx to produce beat signals sigbt on receive path 92. Receive path 92 may include one or more additional mixers (not shown) that convert received reflected radar signals sigrx and/or beat signals sigbt to baseband. The chirps (linear frequency ramps) in radar signals sigtx may each have a temporal duration of T seconds and span a frequency bandwidth of B Hz, resulting in a chirp ramp of B/T Hz/sec. The beat signals sigbt produced by de-chirp mixer 100 may have a constant frequency f_{b} with pulses (in frequency as a function of time) every T seconds. Frequency f_{b} may sometimes be referred to herein as beat frequency f_{b}.

Mathematically, the beat signal sigbt may be expressed as a function of time as x(t,τ), where τ is a “slow” time indicating the time across transmissions of multiple chirps (e.g., the time at which a corresponding chirp begins, or the time at which duration T begins for each chirp) and t is a “fast” time indicating the time within each transmission of a chirp (e.g., where 0≤t≤T for a given chirp). Slow time τ may, for example, be represented by τ=n*T, where n is an integer indexing the number of the corresponding chirp in the series of chirps transmitted on transmit path 90 in radar signals sigtx. The beat signal sigbt may be expressed mathematically using equation 1.

x(t,τ)=Ae^{j(2πf}^{_{b}}^{(τ)t+ϕ}^{_{b}}^{(τ))} (1)

In equation 1, A is the amplitude of beat signal sigbt, beat frequency f_{b}(τ) at slow time τ is given by the equation f_{b}(τ)=(2*B*R(τ))/(c*T), and ϕ_{b}(τ) is the beat phase (e.g., the phase of beat signal sigbt) at slow time τ, given by the equation ϕ_{b}(τ)=(4*π*fₘᵢₙ*R(τ))/c=(4*π*R(τ))/λ, where c is the speed of light, j is the square root of negative one, λ is the wavelength of the beat signal, fₘᵢₙ is the starting frequency of the linear frequency ramp (chirp signal), and R(τ) is the range or distance to external object 42 at slot time τ. The time scale of each transmission within a given chirp (e.g., fast time t) is very short (e.g., microseconds or milliseconds), whereas the time scale across chirp transmissions (e.g., slow time τ) is much longer (e.g., seconds or minutes).

It can be assumed that an animate object presents speed that has little effect on the target position on a the time scale of fast time t. However, over the time scale of slow time τ, animate movement may have significant effect on target position. The animate target movement of interest may sometimes be referred to as semi-static, corresponding to small vibrations of external object 42 on a millimeter scale, characterized by a vibration profile δ_{R}(τ) around some fixed location in space R₀. The above characteristics may then be expressed in the range function R(τ), which may be expressed by the equation R(τ)=R₀+δ_{R}(τ).

Receive path 92 of FIG. 4 may, if desired, also be coupled to communications circuitry 26 for receiving wireless signals 40 using receive antenna 30RX. Doppler processor 96 may receive beat signals sigbt and may generate the Doppler information based on beat signals sigbt (e.g., at operation 64 of FIG. 3). This example is illustrative and non-limiting and, in general, sensing circuitry 28 may be implemented using any desired radar architecture.

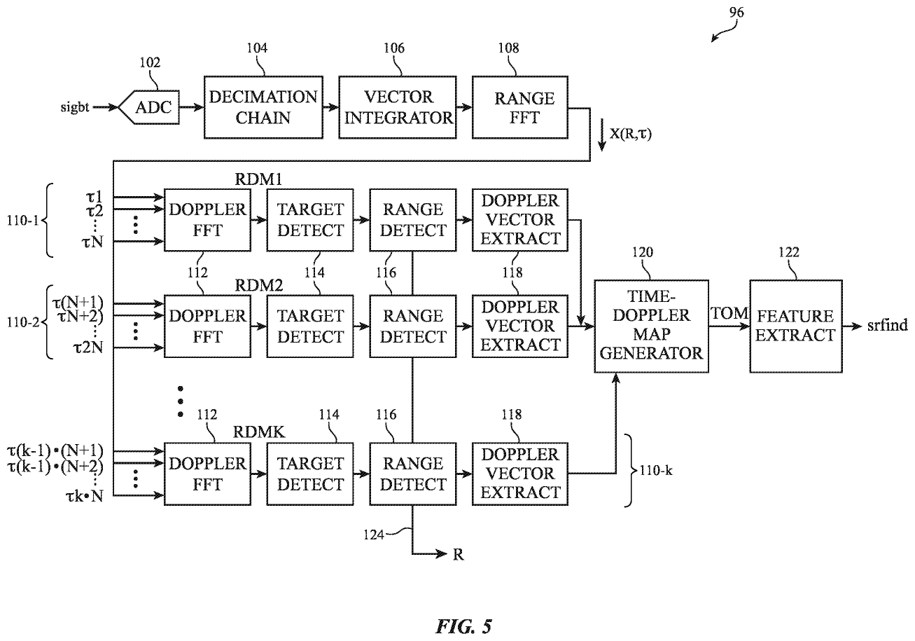

FIG. 5 is a circuit diagram showing one possible architecture for Doppler processor 96 in sensing circuitry 28. As shown in FIG. 5, Doppler processor 96 may include an analog-to-digital converter (ADC) 102 having an input that receives beat signal sigbt and having an output coupled to the input of decimation chain 104. Decimation chain 104 may have an output coupled to the input of vector integrator 106. Vector integrator 106 may have an output coupled to the input of range fast Fourier transform (FFT) circuitry 108. Range FFT circuitry 108 may have an output coupled to an K parallel processing chains 110 (e.g., a first processing chain 110-1, a second processing chain 110-2, a Kth processing chain 110-K, etc.).

Each processing chain 110 may receive a respective set of pulses that were transmitted at different (e.g., non-overlapping) slow times τ (e.g., processing chain 110-1 may receive pulses of the beat signal transmitted at slow times τ1, τ2, . . . , τN, processing chain 110-2 may receive pulses of the beat signal transmitted at slow times τ(N+1), τ(N+2), . . . , τ2N, etc.). Each processing chain 110 therefore operates one of K different respective sets of N beat pulses (corresponding to pulses in the transmitted radar signal sigtx). Each processing chain 110 may include a respective Doppler fast Fourier transform circuitry 112, target detector 114, range detector 116, and Doppler vector extractor 118 coupled in series between the output of range FFT circuitry 108 and input of time-Doppler map generator 120. Range detectors 116 may be coupled to a range output path 124. Time-Doppler map generator 120 may have an output coupled to the input of feature extractor 122.

ADC 102, decimation chain 104, vector integrator 106, and range FFT circuitry 108 may process beat signal sigbt to generate vectors X(R,τ), sometimes referred to herein as channel impulse responses (CIRs). Range FFT circuitry 108 may provide vectors X(R,τ) to processing chains 110. Doppler FFT circuitry 112 in processing chains 110 may process vectors X(R,τ) to generate different respective range-Doppler maps RDM (e.g., processing chain 110-1 may generate range-Doppler map RDM1, processing chain 110-2 may generate range-Doppler map RDM2, processing chain 110-K may generate range-Doppler map RDMK, etc.). Target detectors 114 may detect a target (e.g., external object 42) using the range-Doppler maps. Range detectors 116 may generate ranges R based on the range-Doppler maps (e.g., based on the targets detected by the target detectors) and may output ranges R on range output path 124 (e.g., for comparison with maximum range RMAX while processing operation 74 of FIG. 3). Doppler vector extractors 118 may extract a Doppler vector corresponding to the detected target from each range-Doppler map and may transmit the extracted Doppler vectors to time-Doppler map generator 120.

Time-Doppler map generator 120 may generate time-Doppler map TDM based on the K extracted Doppler vectors received from processing chains 110. Time-doppler map generator 120 may provide time-Doppler map TDM to feature extractor 122. Feature extractor 122 may determine whether external object 42 is on the surface of device 10 based on time-Doppler map TDM. Feature extractor 122 may generate a surface indicator signal srfind that identifies whether external object 42 is on the surface of device 10 (e.g., for comparison with one or more thresholds while processing operation 80 of FIG. 3).

The example of FIG. 5 is illustrative and non-limiting. If desired, Doppler processor 96 may have other architectures. The operations of the K processing chains 110 shown in FIG. 5 may be combined into a single processing chain that performs the operation of each of the K processing chains 110 in (e.g., non-overlapping) sequence/series (e.g., as additional sets of chirps are transmitted and received). The components of Doppler processor 96 (e.g., ADC 102, decimation chain 104, vector integrator 106, range FFT circuitry 108, processing chains 110, time-Doppler map generator 120, and/or feature extractor 122) may be implemented in hardware (e.g., using digital logic gates, analog logic, storage circuitry, one or more processors, controllers, adders, subtractors, integrators, combiners, dividers, comparators, FFT circuits, etc.) and/or software (e.g., using software logic stored on storage in device 10, that operates on beat signals sigbt, and that is executed using one or more processors on device 10).

Doppler processor 96 may generate Doppler information associated with reflected radar signals sigrx to differentiate between cases where the animate target is outside cone 54 (e.g., where θ>θMAX) and is most likely on the surface of device 10 from cases where the animate target is inside cone 54 (e.g., where θ<θMAX) and is thus most likely off the surface of the device. A target on the surface of the device and anchored by it will present a weaker vibration and thus a weaker Doppler profile compared to a target off the surface. If sensing circuitry 28 measures/acquires vibration profile δ_{R}(z) using the radar measurements, sensing circuitry 28 may resolve on-surface targets versus off-surface targets. Since vibration profile δ_{R}(τ) is expressed across multiple chirp transmissions (e.g., the slow time scale), extracting δ_{R}(τ) requires performing and processing multiple sequential chirp transmissions.

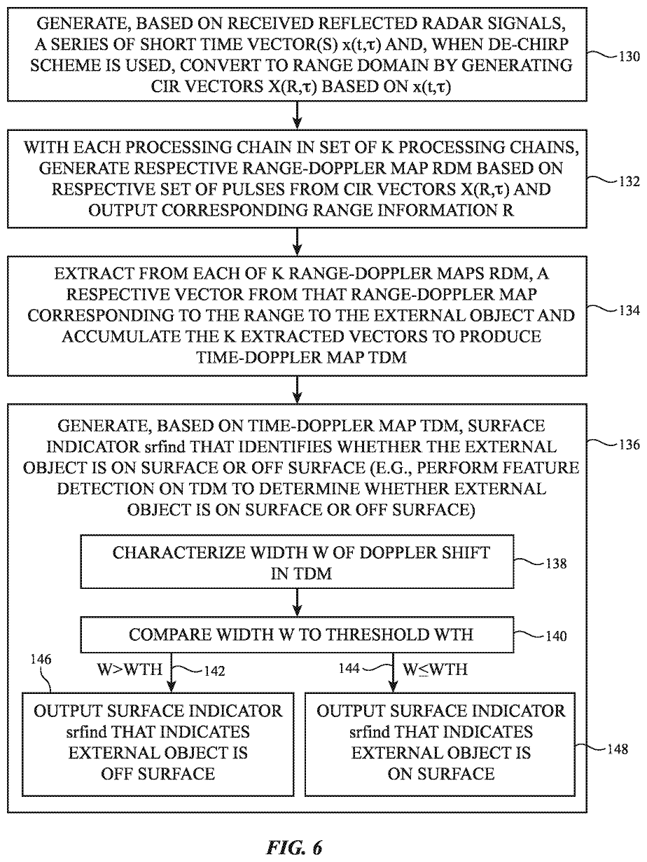

FIG. 6 is a flow chart of illustrative operations that may be performed by Doppler processor 96 of FIG. 5 to generate Doppler information and to determine, based on the Doppler information, whether external object 42 is present on a surface of device 10. The operations of FIG. 6 may be performed after device 10 has begun transmitting radar signals sigtx (e.g., chirps) and receiving reflected radar signals sigrx. The operations of FIG. 6 may, for example, be performed while processing operations 64, 74, and 80 of FIG. 3.

At operation 130 of FIG. 6, Doppler processor 96 may receive a train of echoes (reflected chirps in reflected radar signals sigrx) and may pulse-compress the echoes one-by-one (e.g., some collection of subsequent echoes may be averaged together to increase signal-to-noise ratio (SNR)). This produces a collection of short-time vectors, which are represented by x(t,τ). In implementations where sensing circuitry 28 has a de-chirp architecture (e.g., as shown in FIG. 4), ADC 102, decimation chain 104, vector integrator 106, and range FFT circuitry 108 (FIG. 5) may generate vectors X(R,τ) based on x(t,τ). ADC 102 may convert the signals from the analog domain to the digital domain. Decimation chain 104 may decimate the signals. Vector integrator 106 may integrate the signals. Range FFT 108 may process the vectors such that their amplitude will represent the target RCS distribution across the delay/range dimension.

For example, range FFT circuitry 108 may generate vectors X(f,τ) using the equation X(f,τ)=FFT[x(t,τ)]≈A*δ(f−f_{b}(T))*exp(j*ϕ_{b}(τ)), which can be translated into units of range R (as vectors X(R,τ)) using the equation f(τ)=(2*B*R(τ))/(c*T), such that X(R,τ)≈Â·δ(R−R_{b}(τ))·e^{jϕ}^{_{b}}^{(τ)}. Vectors X(R,τ) are known as channel impulse responses (CIRs).

At operation 132, processing chain(s) 110 in Doppler processor 96 may generate a range-Doppler maps RDM based on a respective set of N pulses collected from vectors X(R,τ). For example, the Doppler FFT circuitry 112 in a given processing chain 110 may consecutively collect N CIRs, may stack the N CIRs together (e.g., as X_{R,τ}=[X(R,τ₁), X(R,τ₂), X(R,τ_{N})]), and may perform an FFT on the N stacked CIRs along the τ dimension. This results in a matrix X_{R,FDOPPLER}, which represents the target properties in terms of range and Doppler frequency (velocity), forming the range-Doppler map RDM for that processing chain 110.

For the case of a target that is moving linearly, R(τ)=R₀+δ_{R}(τ)=R₀+V*τ (where R₀>>v*nT). X_{R,FDOPPLER} will therefore be of the form X_{R,FDOPPLER}=A*δ(R−R₀)*δ(f−fᵥ), where f is the Doppler frequency and fᵥ=(2v/c)*f_{c} is the Doppler frequency matching a velocity v perceived by sensing circuitry 28 operating with a carrier frequency of f_{c}. Generating the range-Doppler map may be repeated in batches of N CIRs (e.g., across K different processing chains 110 or sequentially within a single processing chain 110) to generate a sequence of K range-Doppler maps RDM.

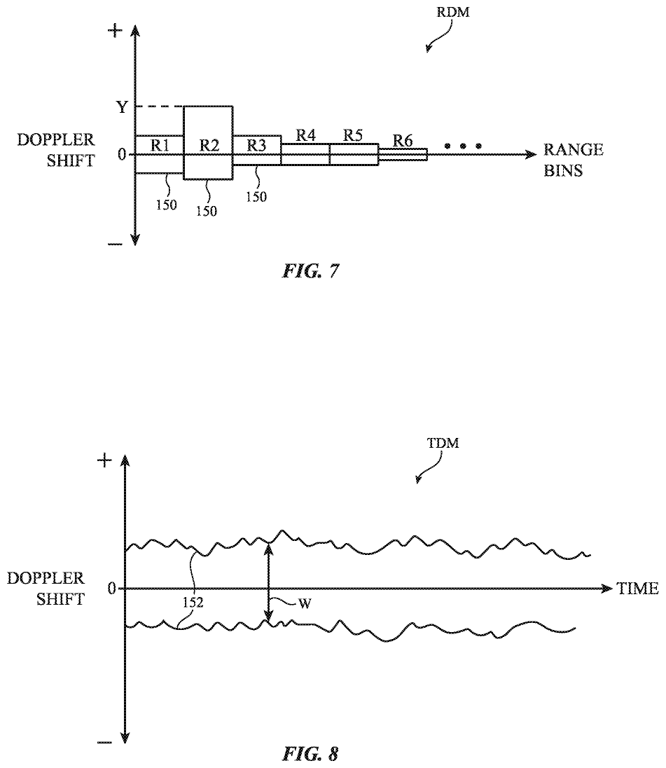

FIG. 7 is a plot illustrating one exemplary range-Doppler map RDM. The horizontal axis of FIG. 7 plots range (e.g., as divided into range bins). The vertical axis of FIG. 7 plots Doppler shift about a Doppler shift of zero (e.g., corresponding to a stationary inanimate target). As shown in FIG. 7, doppler FFT 112 may generate, based on vectors X(R,τ), the measured Doppler shift at different ranges from device 10 and may group the measurements into range bins 150. Target detector 114 (FIG. 5) may identify, based range-Doppler map RDM, which range bin(s) correspond to the presence of an animate target (external object 42). An animate target may be deemed present for range bins having a Doppler shift that exceeds a threshold value, for example. Target detector 114 may, for example, output a list of target ranges or range bins.

Range detector 116 (FIG. 5) may identify the range R of each detected target (e.g., the range of the range bin(s) that has/have a Doppler shift exceeding the threshold value or the range of the range bin that exhibits a peak Doppler shift). For example, range detector 116 may identify range bin R2 as the range to the target object (e.g., because range bin R2 exhibits peak Doppler shift Y or a Doppler shift Y that exceeds a threshold Doppler shift). Range detector 116 may therefore output, as the range R to external object 42, the range corresponding to range bin R2. The range-Doppler map may be continuously generated and updated as additional CIRs are collected.

Since the targets of interest for radio-frequency emission/absorption purposes are semi-static, their range does not change considerable over time (e.g., between range-Doppler maps RDM). As such, a target may be localized on a single range bin on the range-Doppler map, and only a single Doppler vector corresponding to the target's range is of interest out of the entire range-Doppler map. Returning to FIG. 6, at operation 134, Doppler vector extractor 118 may therefore crop out all range bins from range-Doppler map RDM that do not correspond to the presence of a detected target and may output the Doppler vector of each range bin corresponding to the presence of a detected target to time-Doppler map generator 120. In the example of FIG. 7, Doppler vector extractor 118 may crop out all range bins 150 except for the range bin R2, may extract the Doppler vector corresponding to range bin R2 (e.g., the Doppler vector associated with Doppler shift Y), and may output the extracted Doppler vector to time-Doppler map generator 120.

Time-Doppler map generator 120 may accumulate (collect or stack) extracted Doppler vectors as they come in, in units of time, to produce a time-Doppler map (matrix) TDM corresponding to the range bin(s) of the detected target(s). The TDM may represent the evolution of the Doppler vector for the target along time or across range-Doppler maps. FIG. 8 is a plot illustrating one exemplary time-Doppler map TDM that may be accumulated by time-Doppler map generator 120 over time (e.g., from at least the Doppler vector associated with range bin R2 extracted from range-Doppler map RDM of FIG. 7). Curves 152 plot the boundaries of the Doppler shift values (e.g., the Doppler signature) from the accumulated Doppler vectors. As shown by FIG. 8, time-Doppler map TDM may be characterized by a width metric W (e.g., characterizing the width between curves 152). Width metric W may characterize the intensity of the Doppler signature of external object 42.

Returning to FIG. 6, at operation 136, feature extractor 122 (FIG. 5) may generate surface indicator signal srfind based on time-Doppler map TDM. Feature extractor 122 may, for example, process a group of K consecutive Doppler vectors together (e.g., in time-Doppler map TDM) and may extract Doppler signature features from time-Doppler map TDM to determine whether external object 42 is on the surface of device 10 or off the surface of device 10. The feature detection may involve comparing one or more detected features to one or more characteristic features associated with external object 42 being on the surface of device 10 or being off the surface of device 10.

As one example, the Doppler vectors in time-Doppler map TDM may be averaged to yield an average Doppler vector, whose Doppler signature intensity is extracted and used as a feature for feature detection. If desired, feature extractor 122 may generate a width metric W from time-Doppler map TDM (FIG. 8) (at operation 138). Width metric W may be, as examples, the width between curves 152 at any point in time on time-Doppler map TDM, may be an average width between curves 152 over a range of times (e.g., a sub-period) on time-Doppler map TDM, or may be the width of a Gaussian fit (or any other distribution function or kernel) over the distribution of the average Doppler intensity distribution of time-Doppler map TDM.

Width metric W of the Doppler shifts may be indicative of whether or not external object 42 is present on the surface of device 10. For example, larger width metrics W are generally indicative of higher Doppler shift intensity and thus more movement of external object 42 relative to device 10, indicating that the external object is not resting on or supported by the surface of device 10 and is thus in the air over the antennas (e.g., within cone 54). On the other hand, lower width metrics W are generally indicative of lower Doppler shift intensity and thus less movement of external object 42 relative to device 10, such as when object 42 is resting on and supported by the surface of device 10 (e.g., outside cone 54).

At operation 140, feature extractor 122 may compare width metric W to a threshold width metric WTH. If width metric W exceeds threshold width metric WTH, processing may proceed to operation 146 over path 142. This may be indicative of external object 42 not being on the surface of device 10 (e.g., being off-surface). At operation 146, feature extractor 122 may output a surface indicator signal srfind that identifies that external object 42 is not on the surface of device 10. This may be indicative of external object 42 being within cone 54 and device 10 may reduce its maximum transmit power level to satisfy the regulatory requirements (e.g., processing may proceed from operation 80 to operation 86 via path 84 of FIG. 3).

If width metric W is less than or equal to threshold width metric WTH, processing may proceed from operation 140 to operation 148 over path 144. This may be indicative of external object 42 being on the surface of device 10 (e.g., being on-surface). At operation 148, feature extractor 122 may output a surface indicator signal srfind that identifies that external object 42 is on the surface of device 10. This may be indicative of external object 42 being outside cone 54 and device 10 may perform communications without reducing its maximum transmit power level to boost wireless performance while satisfying the regulatory requirements (e.g., processing may proceed from operation 80 to operation 70 via path 82 of FIG. 3).

Feature extractor 122 may compare information from time-Doppler map 120 to any other desired metrics for determining whether external object 42 is on-surface or off-surface. For example, feature extractor 122 may process the shape of the Doppler signature and its behavior over time and may compare the shape/behavior to predetermined shapes/behaviors expected in situations where external object 42 is on-surface or off-surface (e.g., as predetermined and/or updated using a Machine Learning algorithm or other feature recognition algorithms).

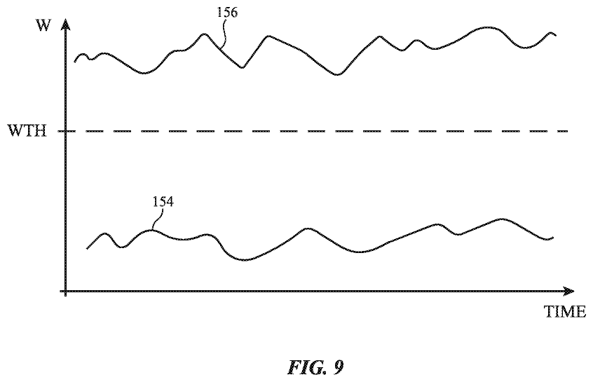

FIG. 9 is a diagram showing how width metric W may vary depending on whether external object 42 is on-surface of off-surface. Curve 154 plots the width metric W that may be gathered from time-Doppler map TDM as a function of time (e.g., while processing operation 138) when external object 42 is on (contacting) the surface of device 10. Curve 156 plots the width metric W that may be gathered from time-Doppler map TDM as a function of time (e.g., while processing operation 138) when external object 42 is off (not contacting) the surface of device 10. As shown by curves 154 and 156, width metric W may be less than threshold width metric WTH when external object 42 is on the surface of device 10 but may exceed threshold width metric WTH when external object 42 is off the surface of device 10. Thus, by comparing the gathered width metric of time-Doppler map TDM to width metric WTH, sensing circuitry 28 may accurately and reliably detect whether external object 42 is located on the surface of device 10 (e.g., for use in adjusting the operation of antennas 30).

In this way, device 10 may accurately detect when external object 42 is present within cone 54 for backing off maximum transmit power level, while also allowing device 10 to use a maximal maximum transmit power level when external object 42 is outside cone 54. Device 10 may perform this assessment even when antennas 30 are arranged in a 1-dimensional array pattern. Even if the antennas are arranged in a 2-dimensional array pattern, object detection based on Doppler shifts as described herein may exhibit less noise and may be more reliable than gathering multiple range measurements from multiple antennas and combining the range measurements to triangulate the angle of external object 42. These Doppler-based techniques involve generating the Doppler or time-Doppler signature of the target (external object 42). If desired, this signature may also be used to differentiate between different types of targets based on the targets' motion or vibration pattern (e.g., some types of external objects may vibrate on the mm scale differently than other types). This type of object insight may be used for emission power management logic. If a target is detected within cone 54 and can be classified as a non-human target, there is no need to minimize emission (e.g., processing may proceed from operation 66 to operation 70 via path 68 of FIG. 3).

The adjustments to maximum transmit power level described herein may additionally or alternatively include adjustments to uplink duty cycle (e.g., adjustment to uplink duty cycle and adjustments to maximum transmit power level may have similar effects for radio-frequency exposure purposes in many contexts). For example, operation 70 of FIG. 3 may include communications without limitation on uplink duty cycle and/or increasing the (maximum) uplink duty cycle used for communications. Similarly, operation 86 of FIG. 3 may include communications with a limitation on uplink duty cycle and/or decreasing the (maximum) uplink duty cycle used for communications.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent with.”

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-9 (e.g., the operations of FIGS. 3 and 6) may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry 18 of FIG. 1, etc.). The processing circuitry may include microprocessors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

What is claimed is:

1. An electronic device comprising:
one or more antennas configured to transmit radar signals and to receive reflected radar signals;
one or more processors configured to detect, based on the reflected radar signals, whether an external object is on a surface of the electronic device; and
a transmitter coupled to the one or more antennas, wherein the transmitter is configured to use the one or more antennas to
transmit wireless signals with a first maximum transmit power level when the external object is detected on the surface, and
transmit the wireless signals with a second maximum transmit power level when the external object is detected off the surface.

2. The electronic device of claim 1, wherein the first maximum transmit power level is higher than the second maximum transmit power level.

3. The electronic device of claim 2, wherein the one or more processors is configured to detect, based on the reflected radar signals, a range to the external object, the transmitter being further configured to use the one or more antennas to transmit the wireless signals with the first maximum transmit power level when the range exceeds a threshold value.

4. The electronic device of claim 2, wherein the one or more processors is configured to detect, based on the reflected radar signals, whether the external object is inanimate, the transmitter being further configured to use the one or more antennas to transmit the wireless signals with the first maximum transmit power level when the external object is inanimate.

5. The electronic device of claim 1, wherein the one or more processors is configured to identify, based on the reflected radar signals, Doppler information associated with the external object, the one or more processors being configured to detect whether the external object is on the surface based on the Doppler information.

6. The electronic device of claim 5, wherein the one or more processors is configured to generate a range-Doppler map based on the reflected radar signal, the one or more processors being configured to detect whether the external object is on the surface based on the range-Doppler map.

7. The electronic device of claim 6, wherein the one or more processors is configured to generate a time-Doppler map based on the range-Doppler map, the one or more processors being configured to detect whether the external object is on the surface based on the time-Doppler map.

8. The electronic device of claim 5, further comprising:
a transmit path coupled to the one or more antennas;
a receive path coupled to the one or more antennas, wherein the radar signals comprises chirp signals; and
a de-chirp mixer on the receive path, wherein the de-chirp mixer is configured to receive the radar signals from the transmit path over a de-chirp path, the de-chirp mixer is configured to receive the reflected radar signals from the one or more antennas, the de-chirp mixer is configured to generate a beat signal based on the radar signals and the reflected radar signals, and the one or more processors is configured to generate the Doppler information based on the beat signal.

9. A method of operating an electronic device, the method comprising:
transmitting, using one or more antennas, radar signals;
receiving, using the one or more antennas, reflected radar signals; and
adjusting, using one or more processors, a maximum transmit power level of the one or more antennas based on Doppler information, the Doppler information being associated with an external object and being generated based on the reflected radar signals.

10. The method of claim 9, wherein adjusting the maximum transmit power level comprises:
reducing, using the one or more processors, the maximum transmit power level when the Doppler information has a first characteristic; and
maintaining or increasing, using the one or more processors, the maximum transmit power level when the Doppler information has a second characteristic that is different from the first characteristic.

11. The method of claim 10, wherein adjusting the maximum transmit power level comprises:
reducing, using the one or more processors, the maximum transmit power level when the Doppler information is indicative of the external object being off a surface of the electronic device; and
maintaining or increasing, using the one or more processors, the maximum transmit power level when the Doppler information is indicative of the external device being on the surface of the electronic device.

12. The method of claim 9, wherein the Doppler information comprises a Doppler signature of the external object and adjusting the maximum transmit power level comprises:
reducing the maximum transmit power level when a width metric of the Doppler signature exceeds a threshold value.

13. The method of claim 9, further comprising:
generating, using the one or more processors, a set of Channel Impulse Response (CIR) vectors in the Doppler information based on the reflected radar signals.

14. The method of claim 13, further comprising:
generating, using the one or more processors, a range-Doppler map in the Doppler information based on the CIR vectors.

15. The method of claim 14, further comprising:
detecting, using the one or more processors, a range to the external object based on the range-Doppler map.

16. The method of claim 14, further comprising:
extracting, using the one or more processors, a Doppler vector from the range-Doppler map; and
accumulating, using the one or more processors, the Doppler vector with additional Doppler vectors to generate a time-Doppler map.

17. The method of claim 16, further comprising:
identifying, using the one or more processors, a feature of the time-Doppler map, wherein adjusting the maximum transmit power level comprises adjusting the maximum transmit power level based on the identified feature of the time-Doppler map.

18. The method of claim 17, wherein the identified feature comprises a width metric of the time-Doppler map and adjusting the maximum transmit power level comprises reducing the maximum transmit power level when the width metric exceeds a threshold value.

19. A method of operating an electronic device, the method comprising:
transmitting, using one or more antennas, radar signals;
receiving, using the one or more antennas, reflected radar signals; and
reducing, using one or more processors, a maximum transmit power level of the one or more antennas when an angle, to an external object and relative to a boresight of the one or more antennas, is less than a threshold angle.

20. The method of claim 19, further comprising:
maintaining or increasing, using the one or more processors, the maximum transmit power level of the one or more antennas when the angle exceeds the threshold angle.
